(19) United States
(12) Patent Application Publication
(10) Pub. No.: US 2026/0222390 A1
(43) Pub. Date: Jul. 30, 2026

(54) NETWORK ADDRESS TRANSLATION PROXY FOR ENABLING ACCESS TO EXTERNAL SYSTEMS FROM A PRIVATE NETWORK

(71) Applicant: Tailscale Inc., Toronto (CA)

(72) Inventors: Maisem J. Ali, Woodinville, WA (US); Adrian Dewhurst, Wellesley (CA); Francis R. Bull, Talent, OR (US); Kabir Sikand, Brooklyn, NY (US)

(21) Appl. No.: 19/461,481

(22) Filed: Jan. 27, 2026

Related U.S. Application Data
(60) Provisional application No. 63/750,604, filed on Jan. 28, 2025.

(51) Int. Cl. H04L 9/40; H04L 61/4511

(52) U.S. Cl. CPC H04L 63/0281; H04L 61/4511; H04L 63/102

(57) ABSTRACT

The technology disclosed herein enables mediated communication between nodes of a private network and external systems using NAT. In a particular example, a method includes allocating, for a proxy node within an internal domain of the private network, a reserved address range in the internal domain. The method further includes receiving, at the proxy node, a name-resolution request indicating an identifier corresponding to an external system in an external domain and, in response to the name-resolution request, selecting a designated address from the reserved address range and associating the designated address with the identifier and the requesting node in a mapping. The method also includes transmitting, to the requesting node, a name-resolution response including the designated address and relaying traffic exchanged between the requesting node and the external system via the proxy node by translating traffic addressed to the designated address into traffic addressed to the external system.

### RELATED APPLICATIONS

This application is related to and claims priority to U.S. Provisional Patent Application 63/750,604, titled “NAT based App Connector,” filed Jan. 28, 2025, and which is hereby incorporated by reference in its entirety.

### BACKGROUND

Virtual Private Networks (VPNs) work by creating a logical network overlay that allows devices to communicate securely over underlying networks, such as a public or untrusted network (e.g., the Internet). The overlay is achieved through a process called encapsulation, where the data packets sent between devices are wrapped inside additional packets that include encrypted information. For instance, when a VPN endpoint device sends data through a VPN, a packet carrying the data is encrypted and then encapsulated with a new packet header that includes a public IP address of another VPN endpoint device as the destination. This encapsulated packet is then sent over a public network to the destination VPN endpoint device.

At the destination VPN endpoint device, the outer packet header is stripped away to reveal the original encrypted packet. The original packet is then decrypted, allowing the data to be processed by the device. In some examples, the VPN endpoint device may be a VPN server operating as a gateway to the public network. In those examples, the decrypted original packet may be transmitted to a destination IP address on the public network identified in a header of the original packet. The above encryption method ensures that the data remains confidential and secure as it travels over potentially insecure networks, as only the VPN destination endpoint can decrypt and access the original information. By creating a secure tunnel through encryption and encapsulation, VPNs effectively simulate a private network over a public infrastructure, providing privacy and security for users.

VPN endpoints may also connect with systems external to the VPN. Communications with the external systems are not encapsulated like those between endpoints of the VPN because the external systems will not be able to decrypt the encapsulated packets. Those external communications, therefore, may not be subject to controls implemented by the VPN. Those controls may include permissions to access external applications associated with the VPN (e.g., an entity operating the VPN may subscribe to an application for use by endpoints on the VPN). An external application would typically require information indicating that an endpoint is associated with the VPN prior to enabling the endpoint to access the application.

### SUMMARY

The technology disclosed herein enables communication between nodes of a private network and external systems through an intermediary proxy node that utilizes network address translation to map internal requests to externally reachable destinations. In a particular example, a method includes allocating, for a proxy node within an internal domain of the private network, a reserved address range in the internal domain. The method further includes receiving, at the proxy node, a name-resolution request from a requesting node in the internal domain indicating an identifier corresponding to an external system in an external domain and, in response to the name-resolution request, selecting a designated address from the reserved address range and associating the designated address with the identifier and the requesting node in a mapping maintained by the proxy node. The method also includes transmitting, to the requesting node, a name-resolution response including the designated address and relaying traffic exchanged between the requesting node and the external system via the proxy node by translating traffic addressed to the designated address into traffic addressed to the external system.

In another example, an apparatus is provided including one or more computer-readable storage media and one or more processing systems operatively coupled with the one or more computer-readable storage media. Program instructions stored on the one or more computer-readable storage media, when read and executed by the one or more processing systems, direct the apparatus to receive a reserved address range in an internal domain of the private network. The program instructions further direct the apparatus to receive a Domain Name System (DNS) request from a requesting node in the internal domain that indicates a domain name corresponding to an external domain and allocate a designated address from the reserved address range to communications associated with the DNS request. The program instructions also direct the apparatus to transmit, to the requesting node, a name-resolution response that includes the designated address, receive traffic directed to the designated address over the private network, and relay the traffic to a resource in the external domain.

In another example, a system is provided having a control plane and a proxy node. The control plane is configured to identify a set of domain names to be mediated by a proxy node operating in an internal domain of the private network and configure the proxy node with a reserved address range and with instructions to respond to name-resolution requests for the set of domain names with designated addresses drawn from the reserved address range. The control plane is further configured to direct nodes in the internal domain to send the name-resolution requests for the set of domain names to the proxy node. The proxy node is configured to maintain mappings between designated addresses in the reserved address range, the nodes, and the set of domain names and provide name-resolution responses to the nodes in the internal domain that include the designated addresses. The proxy node is further configured to advertise one or more subnet routes to the reserved address range within the internal domain and relay traffic between the nodes in the internal domain and external systems indicated by the domain names using network address translation based on the mappings.

### BRIEF DESCRIPTION OF THE DRAWINGS

FIG. 1 illustrates an implementation for enabling controlled communication between nodes in a private network and resources.

FIG. 2 illustrates an operation to enable controlled communication between nodes in a private network and resources.

FIG. 3 illustrates an operational scenario for enabling controlled communication between nodes in a private network and resources.

FIG. 4 illustrates an operational scenario for enabling controlled communication between nodes in a private network and resources.

FIG. 5 illustrates an operational scenario for enabling controlled communication between nodes in a private network and resources.

FIG. 6 illustrates an operation to enable controlled communication between nodes in a private network and resources.

FIG. 7 illustrates address resources for enabling controlled communication between nodes in a private network and resources.

FIG. 8 illustrates a computing system for enabling controlled communication between nodes in a private network and resources.

### DETAILED DESCRIPTION

The private-network proxy nodes herein include a mechanism enabling nodes within a private network to obtain controlled access via the proxy node to systems located outside that network. Unlike approaches that rely on domain-specific route advertisements or direct upstream resolution, the proxy node performs address-translation-based mediation and request mapping. As a result, traffic originating within the private network is relayed to the correct external destinations while remaining subject to the identity, policy, and auditing controls imposed within the private network. By concentrating these mediation responsibilities in an intermediary proxy node, external connectivity can be managed without modifying the external systems themselves or exposing internal resources to public networks.

In an example, the proxy node is allocated a reserved portion of address space (e.g., IP address space) within the private network and is configured to answer name-resolution requests for designated external identifiers with translated internal addresses drawn from that space. When a node within the private network initiates a connection to such a translated address, the proxy node determines the external destination associated with the request, establishes an outbound connection to the destination on behalf of the internal node, and relays traffic between the two endpoints. This translation-based approach decouples internal and external addressing, enabling the private network to regulate which external systems may be accessed while remaining indifferent to the addressing format or protocol versions used by those systems.

In some examples, the proxy node may generate translated addresses dynamically, including on a per-request or per-client basis, and may return these addresses with short time-to-live values. Dynamic translation reduces the need for large or frequently changing route tables on client devices and mitigates problems associated with domain-level routing approaches, such as excessive route churn, platform-specific routing limitations, connection coalescing behaviors in client software, or conflicts arising when multiple external identifiers resolve to the same upstream address. Since the mapping between translated and external addresses is maintained locally on the proxy node, different clients can reuse internal address ranges without interfering with one another, and multiple intermediary proxy nodes may be deployed for redundancy or geographic distribution.

In practice, such redundancy is often required to meet high-availability objectives, such that multiple proxy nodes are capable of handling substantially identical traffic on behalf of private-network nodes. Deployment of proxy nodes in a redundant configuration enable connections to continue without interruption by switching to another proxy node when a previous proxy node becomes unavailable. However, the use of network address translation introduces a finite pool of internal addresses whose meanings must remain unambiguous across the system, which constrains naïve scaling approaches.

A limited resource in such configurations is that pool of internal network addresses reserved for translation. Each designated address drawn from the pool must have a single, well-defined association at any given time so that traffic addressed to that address can be correctly interpreted. If different proxy nodes associate the same internal address with different external destinations or clients, failover or routing changes may result in inconsistent interpretation of traffic and loss of connectivity. The proxy nodes herein may include a consensus algorithm to ensure consistent address usage across proxy nodes.

This translation-centric design also addresses several operational challenges that arise when relying on domain-scoped route advertisements. For environments in which access must be mediated for large numbers of external domains or dynamically changing hostnames, maintaining per-domain routing information can exceed client limits or cause undesirable reconfiguration overhead. Further, when multiple external identifiers map to shared public infrastructure or when client software reuses existing connections across services, domain-routed approaches may inadvertently deliver traffic to the wrong upstream target. By assigning translated addresses tied directly to the proxy node's mapping state, the present approach ensures deterministic routing of traffic without requiring persistent per-domain routes on the client devices.

Since the proxy node controls both the name-resolution response and the subsequent connection mediation, access policies can incorporate information known within the private network, including user or device identity, group membership, and administrative settings. Before establishing an outbound connection, the proxy node may evaluate whether the requesting node or user is authorized to access the target external system. This ensures that traffic to external systems remains subject to the same identity-aware controls that protect internal resources, while keeping external systems insulated from internal addressing or identity information.

Although examples herein describe the use of reserved internal address ranges for address translation, the principles of operation do not depend on a particular addressing format or scheme. The proxy node may allocate translated addresses from configurable pools, use different address families for internal and external communication, or support varying mapping lifetimes depending on operational requirements. Multiple intermediary proxy nodes may be deployed in configurations that share or subdivide address ranges, enabling high availability, load distribution, or regional proximity without introducing address-mapping conflicts.

The address translation performed by a proxy node may operate across address families, including NAT44, NAT64, and NAT46, allowing nodes in a private network's internal domain to use one address family while an external domain is reachable using another. A proxy node may translate both addresses and, where applicable, protocol semantics (e.g., synthesizing DNS AAAA records from A records or vice versa) so that the mediation remains transparent to endpoints on either side of the proxy node.

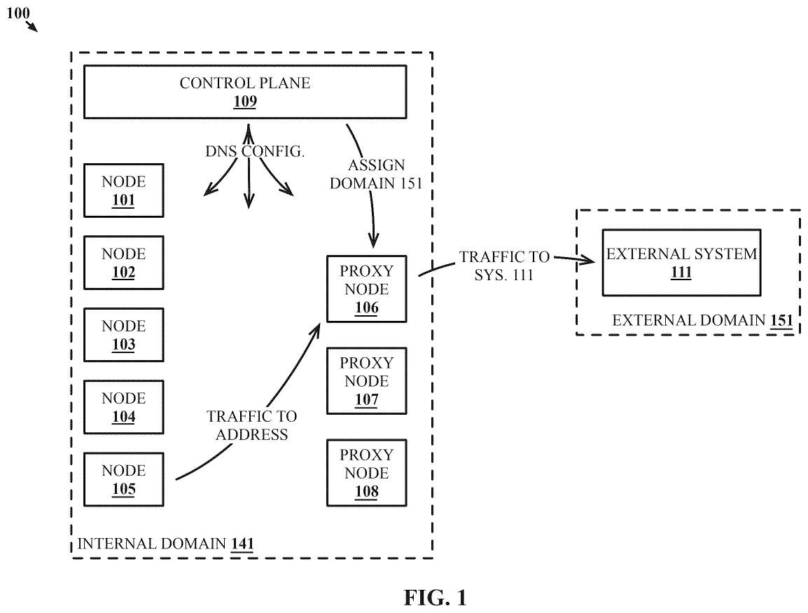

FIG. 1 illustrates implementation 100 for enabling controlled communication between a private network and external systems. Implementation 100 includes nodes 101-108 in internal domain 141 and external system 111 in external domain 151. The logical network formed among the nodes of internal domain 141 is managed by control plane 109. The control plane may execute on a dedicated system inside or outside the internal domain, may operate on one or more of nodes 101-108, may be distributed across a subset of node 101-108s, or may run in any other suitable configuration.

Internal domain 141 represents a private network environment, such as a virtual private network or other logical overlay network. This environment uses authentication and security mechanisms to ensure that only authorized devices can participate in the private network. The overlay may be provided over underlying physical infrastructure that includes wired or wireless links, routers, switches, computing devices, and other networking components. Portions of that infrastructure may also underlie communications within external domain 151, which may include public networks such as the Internet. External system 111 represents any resource, service, host, or endpoint accessible from external domain 151.

A device may become one of nodes 101-108 by executing a client application that communicates with control plane 109 to complete onboarding to internal domain 141. During onboarding, the client application provides credentials or other proofs of identity and, upon successful verification, control plane 109 provisions the device with network configuration information such as addresses for internal domain 141, routing information, and cryptographic material (e.g., public keys, certificates, and session parameters) enabling secure encapsulation and authenticated communications between nodes 101-108. In some examples, control plane 109 also supplies discovery information (e.g., bootstrap peers, relay endpoints, or preferred egress nodes) so the newly added node can locate, authenticate, and securely communicate with other nodes 101-108 regardless of the underlying networks over which those communications occur.

Control plane 109 manages internal-domain membership and facilitates secure interactions among nodes 101-108. As devices join the private network, control plane 109 verifies their identities, assists with key exchanges, and provides them with addressing information within internal domain 141. Control plane 109 may also maintain network topology information and synchronize state across nodes to ensure that they can reliably discover and communicate with one another, even when devices move between underlying networks or change connectivity.

In implementation 100, control plane 109 also designates one or more of nodes 101-108 to be an intermediary proxy node within internal domain 141 to handle communications with external system 111. Instead of relying on external-domain route advertisements, the proxy node may perform functions such as responding to internal name-resolution requests for selected external identifiers and translating those requests into internal addresses. This allows internal nodes to direct their outbound traffic to the proxy node when attempting to access external systems like external system 111. Three proxy nodes 106-108 are shown in this example but control plane 109 may designate any number of nodes to be proxy nodes depending on network configuration. While shown as being proxy nodes, proxy nodes 106-108 may otherwise operate and connect to the private network like any other node. In some examples, a user may designate which of nodes 101-108 should be proxy nodes, control plane 109 may select nodes to be proxy nodes (e.g., based on location of the node, compute/network resources of the node, device type of the node, or some other factor—including combinations thereof), or the proxy nodes may be selected using some other mechanism.

By mediating traffic through the proxy node, the private network can ensure that communications with external systems remain subject to internal authentication, policy enforcement, and audit controls. Internal nodes 101-108 do not communicate directly with the external system 111. Rather, nodes 101-108 send traffic to the proxy node, which then establishes and maintains the corresponding external connection on their behalf. This arrangement provides a single controlled point through which external access occurs, preserving both the security posture and management simplicity of the private network.

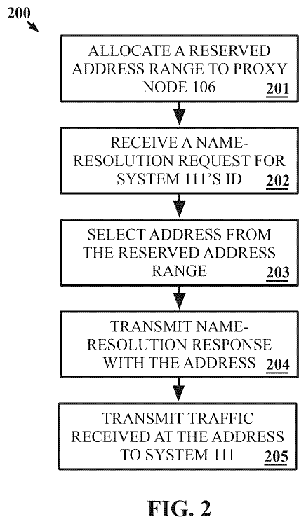

FIG. 2 illustrates operation 200 to enable controlled communication between nodes in a private network and resources. Operation 200 uses proxy node 106 as an example but similar operations may be performed with respect to proxy node 107 and proxy node 108. In many deployments, multiple proxy nodes operate concurrently to provide redundancy, load balancing, or regional optimizations. In such cases, each proxy node participates in a coordinated control-plane configuration process and operates on its own portion of the internal address space while jointly enabling seamless access to external systems. In operation 200, control plane 109 allocates a reserved address range in the address space of internal domain 141 to proxy node 106 for proxy purposes (step 201). Proxy node 106 may also be assigned a private network address outside of the reserved address range for non-proxy related private network communications. In examples with multiple proxy nodes, the reserved address range allocated to proxy node 106 may be a portion of a larger address range allocated for proxy purposes. For instance, each of proxy nodes 106-108 may receive a non-overlapping portion of the overall reserved address range to avoid conflicts. In some examples, control plane 109 dynamically adjusts the size of the reserved portion based on observed utilization or anticipated workload, such as increasing the portion when more connections to external system 111 are expected. In other cases, the subdivision may be performed according to a static configuration that ensures predictable address planning across internal domain 141. The allocation may also be updated over time to support failover, redistribution of traffic, or addition of new proxy nodes.

To enable redundant proxy nodes to operate without statically splitting the reserved address pool, some examples may employ a coordination mechanism in which the proxy nodes maintain a shared view of address allocations. In such configurations, proxy nodes 106-108 may participate in a consensus algorithm that ensures state-changing operations related to address allocation are applied in a consistent order across proxy nodes 106-108. This permits any proxy node to safely allocate from the shared pool while preserving the invariant that each internal address has a single, system-wide meaning at any given time. For example, the consensus-coordinated state may include commands to checkout a designated address for use in response to a name-resolution request, as well as commands to update a last-used indicator for an address when traffic associated with that address is observed. Such commands may be routed to a leader proxy node selected by the consensus algorithm and replicated to other proxy nodes so that each proxy node maintains a consistent view of address usage and expiration eligibility.

After being allocated the reserved address range, proxy node 106 receives a name-resolution request requesting a network address corresponding to an identifier for external system 111 (step 202). The identifier may correspond to external system 111 specifically or to external domain 151. The identifier may be a domain name, and the name-resolution request may be a Domain Name System (DNS) request. The request may originate from a node operating within internal domain 141, such as node 105, after that node attempts to connect to an application or service in external domain 151. In some embodiments, control plane 109 configures nodes 101-105 so that DNS queries for selected domain names are automatically routed to proxy node 106 rather than to a public resolver, ensuring all access attempts pass through the mediated flow. The identifier may also represent a wildcard domain, such as an entire enterprise SaaS namespace, or may represent a label used by an internal application that resolves indirectly to external system 111. In some examples, the private network may include policies that determine which identifiers require proxy mediation, allowing certain classes of external destinations to be accessed only through designated proxy nodes for security or compliance reasons.

Although many examples herein describe name-resolution using Domain Name System (DNS), the techniques herein are not limited to DNS. In some examples, the identifier corresponding to external system 111 is resolved by a private directory, an application-specific service discovery mechanism, or a control-plane-mediated lookup that returns the designated address from the reserved address range. In each case, proxy node 106 associates the designated address with node 105 and with the identifier in a mapping and mediates the resulting traffic as described.

Proxy node 106 selects an address to associate with the request from the reserved address range (step 203). Proxy node 106 may select the address arbitrarily, at random, or by using address-selection criteria. Proxy node 106 may then store the selected address in a mapping indicating the context in which the address will be used. For instance, the mapping may indicate the address, a node that requested the address (e.g., node 105), the identifier associated with the request, or some other type of information that enables proxy node 106 to later properly route traffic associated with the request and selected address. In additional examples, proxy node 106 may store metadata such as timestamps, connection state, access-policy decisions, the protocol being used, or session identifiers from the requesting node. Proxy node 106 may also track whether the selected address is already mapped for that requesting node or whether the mapping is shared across multiple identifiers associated with the same external service. In some cases, address selection may follow a least-recently-used strategy to promote even utilization across the reserved address range. In others, deterministic hashing may be used so that repeated requests for the same identifier from the same requesting node reliably produce the same designated address, improving caching behavior and reducing mapping churn. The mapping may be maintained in memory for fast lookup or may be persisted to storage to survive restart of proxy node 106. The mapping may also be replicated to other proxy nodes or to control plane 109 to support failover.

Proxy node 106 transmits a response to the request indicating that the requesting node (e.g., node 105) should direct traffic associated with the identifier to the selected address (step 204). When proxy node 106 receives traffic directed to the address from the requesting node, proxy node 106 directs the traffic to external system 111 (step 205). Likewise, proxy node 106 will direct traffic received from external system 111 back to the requesting node from the address. Proxy node 106 may have determined the address of external system 111 by performing its own address lookup (e.g., using the public DNS). Although, from the perspective of the requesting node, the requesting node may be unaware that it is communicating with external system 111 through a proxy node. In some implementations, proxy node 106 establishes a new outbound connection to external system 111 and then stitches that outbound connection with an inbound connection received at the designated address. In others, proxy node 106 may implement protocol-level mediation, such as terminating encrypted sessions, performing TLS inspection, or injecting additional authentication tokens when required by external system 111.

The routing from internal domain 141 to external domain 151 may involve additional security layers such as firewall rules, identity-based authorization checks, or device posture validation, consistent with the zero-trust techniques described in the provisional application. Proxy node 106 may also generate telemetry and logs describing each proxied session, which may be forwarded to control plane 109 for monitoring, analytics, or threat detection. In some cases, proxy node 106 may also detect inactivity or policy changes and proactively close sessions or release addresses, ensuring the reserved address space is efficiently reused. To further support identity-aware authorization, control plane 109 may distribute identity information for nodes operating in internal domain 141 so that, when a node receives packets from another node, the receiving node already possesses the information necessary to determine an identity associated with the source address of those packets. For example, control plane 109 may provision node-specific identity material (e.g., certificates, public keys, or signed identity descriptors that include user identity, device identity, group membership, and device posture) and disseminate corresponding verification data to proxy node 106. When node 105 initiates traffic toward the designated address selected from the reserved address range, proxy node 106 can validate the identity associated with node 105 by verifying the source address against the disseminated identity information, by authenticating a per-connection or per-flow token embedded in the traffic (e.g., a signed header, a client certificate presented during mutual authentication, or a cryptographic tag carried by an overlay), or by consulting a cache of recent identity-resolution results populated from control plane 109.

In some implementations, identity binding is achieved through cryptographic associations between node addresses and issued credentials so that only traffic originating from node 105 using its assigned credentials is accepted for the designated address. For instance, proxy node 106 may require mutual authentication on an internal connection before stitching the internal connection with an outbound connection to external system 111, and may reject or quarantine flows that present stale, revoked, or mismatched identity material. In other implementations, identity can be inferred from overlay-network metadata or tunnel state established under the direction of control plane 109, such that packets arriving from node 105 over a particular secure tunnel endpoint are inherently attributable to the identity of node 105 without inspecting application payloads. As an alternative when explicit identity proofs are unavailable in-band, proxy node 106 may perform a control-plane lookup keyed by the source address and recent registration events to retrieve the current identity record for node 105, optionally requiring corroborating signals, such as recent heartbeat attestations or device-posture evidence before allowing traffic to be relayed to external system 111.

Policy evaluation may combine the validated identity of node 105 with the identifier associated with external system 111, time-of-day constraints, administrative configuration, and posture information to determine whether to permit, deny, or require step-up actions (e.g., re-authentication or re-attestation) before forwarding. In some examples consistent with the provisional application, proxy node 106 may tag the mapping it creates for the designated address with the identity of node 105 and with the policy grants active at the time of name-resolution, and may re-evaluate those grants on significant events such as token expiry, posture change, or administrative update pushed by control plane 109. If re-evaluation fails, proxy node 106 may terminate the stitched connection, revoke the mapping, and release the designated address back to the reserved address range. This identity-aware operation ensures that only traffic attributable to an authorized identity associated with node 105 is relayed to external system 111 through proxy node 106, while also enabling rapid, centralized revocation and auditability across internal domain 141.

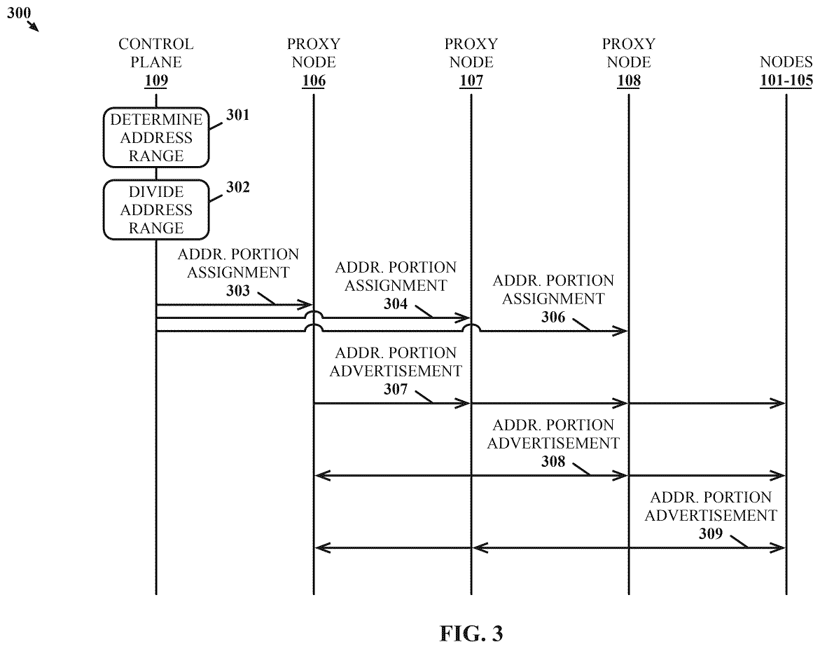

FIG. 3 illustrates operational scenario 300 for enabling controlled communication between nodes in a private network and resources. In this example, control plane 109 determines an address range within internal domain 141 that should be reserved for network address translation (NAT) relay purposes (step 301). The determination may be based on the overall address plan of internal domain 141, expected connection volume to external domain 151, or administrative policy that segregates proxy-mediated traffic from other internal traffic. The reserved address range may include IPv4 addresses, IPv6 addresses, or a combination thereof, and may be contiguous or composed of multiple non-contiguous blocks. Reserving a dedicated range allows other nodes in internal domain 141 to route traffic intended for proxy mediation in a predictable manner without creating overlap with addresses assigned directly to endpoints.

Control plane 109 divides the reserved address range among proxy nodes 106-108 (step 302). One approach to maintaining unambiguous use of translated addresses is to divide the reserved address range into non-overlapping portions and assign each portion exclusively to a respective proxy node. Under this pool-splitting approach, each proxy node allocates designated addresses only from its assigned portion, ensuring that no two proxy nodes simultaneously assign the same internal address. While this enables redundant deployment of proxy nodes, it effectively reduces the number of addresses available to each proxy node and can exacerbate address exhaustion as additional proxy nodes are introduced. Control plane 109 may have already determined that proxy nodes 106-108 should be proxy nodes or may make the determination at this step. The number of addresses in the address range may be divided evenly amongst proxy nodes 106-108 or may be distributed in some other amount. For example, proxy node 106 may be allocated a larger portion of the reserved address range if proxy node 106 is expected to handle more traffic due to geographic proximity, hardware capacity, or current load. In some cases, control plane 109 may reserve portions of the address range for future proxy nodes not yet deployed, enabling expansion without reconfiguration of existing nodes. The division may also be adjusted dynamically in response to failures, maintenance events, or observed traffic patterns.

Control plane 109 notifies each of proxy nodes 106-108 of the respective address portions that are assigned thereto (steps 303-306). The notifications may be delivered over a secure control channel established between control plane 109 and each proxy node, and may include metadata such as lease duration, priority, or instructions to retain or release portions under certain conditions. In some implementations, the notifications may be versioned or sequenced so that proxy nodes 106-108 can safely transition between address assignments without dropping active connections.

After receiving the notifications from control plane 109, each of proxy nodes 106-108 advertises the respective address portions to other nodes in internal domain 141 (steps 307-309). The advertisement may be performed using routing protocols, overlay-network announcements, or control-plane-distributed routing tables such that packets addressed to a given portion of the reserved address range are forwarded to the appropriate proxy node. While shown as occurring at substantially the same time, control plane 109 may add or remove proxy nodes and assign or reassign reserved addresses at different times. During reassignment, proxy nodes may continue handling existing sessions while new sessions are directed according to updated advertisements, enabling graceful migration of traffic.

In various examples, the advertisements issued by proxy node 106 may include one or more subnet routes that encompass the reserved address range rather than individual host routes. Advertising aggregated prefixes enables any packet addressed to an internal address within the reserved range to be forwarded to proxy node 106 without per-address route churn and allows rapid takeover by another proxy node (e.g., proxy node 107 or proxy node 108) by re-advertising the same prefixes when control plane 109 performs reassignment. The routing advertisements may be propagated using overlay-network control messages, software-defined networking updates, or interior gateway protocols, and may include metrics that guide nodes in internal domain 141 to prefer a designated proxy node while retaining others for failover.

In response to detection of a failover event affecting a proxy node, control plane 109 may transfer at least a portion of the different portions of the reserved address range that had been allocated to the failed node to a different proxy node. For example, if proxy node 107 fails, control plane 109 may reassign proxy node 107's portion of the reserved addresses to proxy node 106 and direct proxy node 106 to advertise the corresponding subnet routes and, optionally, to assume responsibility for any replicated mappings associated with those addresses. The reassignment may include withdrawal of the failed node's routes, timed introduction of the replacement routes to avoid loops, and synchronization of any mapping state previously mirrored to control plane 109 or to peer proxy nodes, thereby enabling existing sessions to drain where possible and new sessions to be established without interruption.

When address allocation is coordinated through a consensus mechanism, a proxy node assuming responsibility after a failover event can continue to perform address management using the previously established allocation state. Because address assignments and last-used updates have been replicated among the proxy nodes, the replacement proxy node can honor existing address associations and expiration decisions, allowing nodes to continue using previously issued designated addresses without semantic inconsistency following the failover.

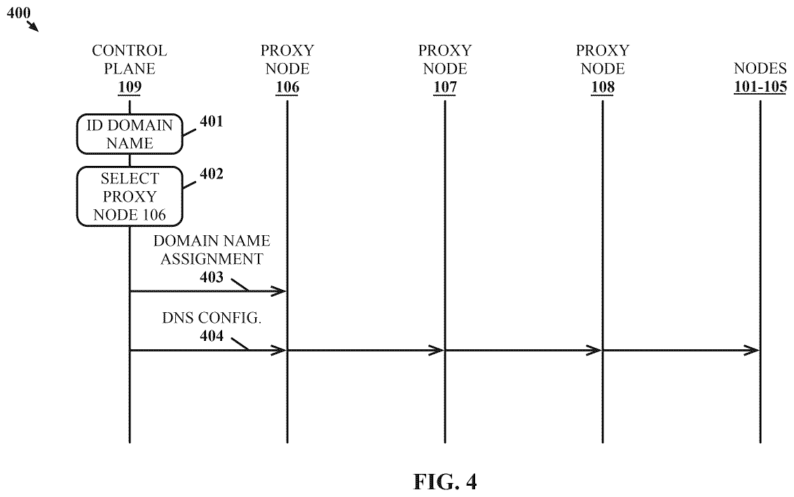

FIG. 4 illustrates operational scenario 400 for enabling controlled communication between nodes in a private network and resources. Operational scenario 400 occurs after operational scenario 300 has completed. In this example, control plane 109 identifies a domain name of a resource that should be routed through a proxy node (step 401). The domain name may correspond to external system 111, to a service hosted within external domain 151, or to a set of related services identified by a wildcard or suffix. Control plane 109 may make this determination based on security policies, compliance requirements, application sensitivity, or administrative configuration that specifies which external destinations must be mediated.

Control plane 109 determines that proxy node 106 should be the proxy node to handle communications associated with the domain name (step 402). The determination may take into account the address portions currently assigned to proxy node 106, the load or health status of proxy nodes 106-108, geographic or network proximity to nodes 101-105, or characteristics of the external resource. In some cases, control plane 109 may select multiple proxy nodes for redundancy, with one designated as primary and others as backups.

Control plane 109 notifies proxy node 106 that the domain name has been assigned thereto (step 403). The notification may include policy requirements, caching behavior, or instructions regarding how aggressively connections should be reused or expired. Proxy node 106 may store the domain name association locally so that subsequent name-resolution requests and traffic flows can be handled consistently.

Control plane 109 also provides a DNS configuration to nodes 101-108 that indicates DNS requests for the domain name should be sent to proxy node 106 (step 404). The configuration is sent to proxy node 106 as well since there may be situations where proxy node 106 uses the domain name to contact external system 111. The DNS configuration may provide a private network address assigned to proxy node 106 in internal domain 141 outside of the address range used for proxy relay purposes. In some examples, a private network address may be assigned to proxy node 106 specifically for DNS message exchanges. In additional examples, the DNS configuration may include routing rules, priority orderings, or fallback behavior specifying when a domain name may be resolved by another proxy node or by an external DNS resolver.

In some examples, proxy node 106 may implement or is fronted by a Domain Name System (DNS) service for internal domain 141. Control plane 109 instructs nodes in internal domain 141 to direct DNS requests for a set of identifiers, including the domain name, to this DNS service. The DNS service may be co-located with proxy node 106 or may be a distinct logical component that consults proxy node 106 to allocate a designated address from the reserved address range and returns that address in the name-resolution response. The DNS service may cache designated addresses subject to their time-to-live values, perform negative caching for non-mediated domains, and apply policy to determine whether a request should be answered locally, forwarded to another proxy node (e.g., proxy node 107 or proxy node 108), or resolved externally.

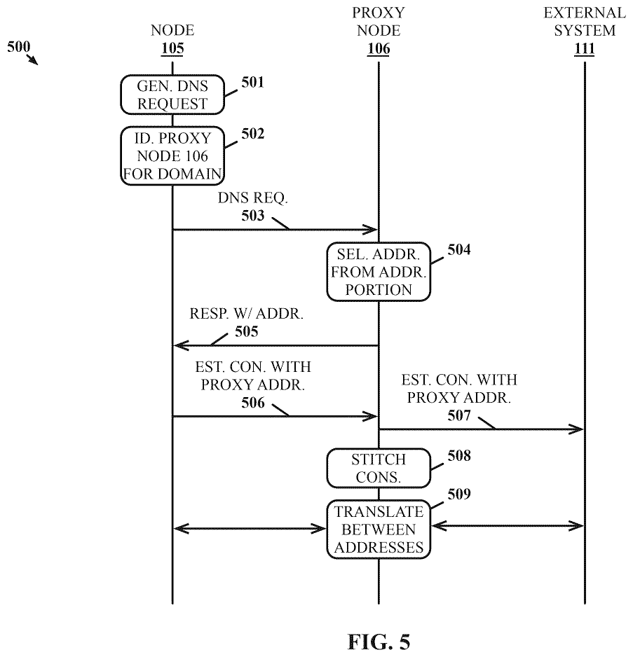

FIG. 5 illustrates operational scenario 500 for enabling controlled communication between nodes in a private network and resources. Operational scenario 500 occurs after operational scenario 400 has completed. In this example, node 105 generates a DNS request with the domain name from operational scenario 400 (step 501). The DNS request may be generated at the instruction of a user, such as input into a browser address bar, may be generated by an application executing at node 105 to contact a resource, or may be generated automatically as part of background service discovery or update checks.

Node 105 determines that DNS request should be sent to the private network address of proxy node 106 according to the DNS configuration received from control plane 109 (step 502). The DNS configuration may also include other domain names that should be sent to proxy node 106 for resolution, domain names that should be sent to proxy node 107 or proxy node 108 for resolution, or domain names that should be sent to some other DNS server, such as a public DNS nameserver. In some implementations, a private network client executing at node 105 intercepts DNS requests and applies the configuration to select the appropriate destination. The DNS request may initially be generated for a different DNS resolver but may be intercepted by the private network client, which rewrites the destination address to that of proxy node 106.

Node 105 sends the DNS request over the private network to proxy node 106 (step 503). Sending the DNS request to proxy node 106 may include directing the DNS request packet to a private network address of proxy node 106 in internal domain 141. A private network client at node 105 may encapsulate the packet using an encryption key for proxy node 106 or a key negotiated with proxy node 106 to open a tunnel, and send the encapsulated packet to a public network address over a public network. Proxy node 106 may then decapsulate the received encapsulated packet to extract the original DNS request. This encapsulation allows DNS traffic to be protected against inspection or tampering while traversing intermediate networks.

Proxy node 106 selects one of the private network addresses available in proxy node 106's portion of the reserved network addresses assigned to associate with the DNS request (step 504). Any one of proxy node 106's portion of the addresses will do as long as the address is not already currently associated with node 105, such as with a different domain name request previously received from node 105. The same address may, however, be associated with another node, and proxy node 106 can distinguish between communications received from different nodes using identity information, tunnels, or connection context. In some cases, proxy node 106 reuses an existing association for node 105 and the same domain name if it remains valid, reducing latency and conserving address space.

After selecting the address, proxy node 106 sends a DNS response over the private network to node 105 (step 505). Proxy node 106 may send the response by reversing the encapsulation process. Upon receiving the DNS response, node 105 sends a communication associated with the domain name to the address from the DNS response. Because proxy node 106 advertised that addresses in the reserved address portion should be routed to proxy node 106, the communication is routed accordingly. These communications enable proxy node 106 to establish a connection between node 105 and proxy node 106 (step 506). Proxy node 106 in response establishes a connection to external system 111 (step 507). Proxy node 106 may itself perform a DNS lookup using public nameservers or other external resolution mechanisms to determine how to reach external system 111.

Once both connections are established, proxy node 106 stitches internal and external connections together (step 508). This enables proxy node 106 to translate network addresses when communications are exchanged between node 105 and external system 111 (step 509). Translation may involve substituting addresses, tracking ports, maintaining session state, or enforcing protocol-specific behavior so that communications appear continuous and transparent to both endpoints.

Before relaying traffic toward external system 111, proxy node 106 may verify that packets addressed to the designated address were received from the same requesting node for which the mapping was created. This verification may use tunnel endpoint identity, mutual-authentication results, cryptographic tokens bound to node 105, or a source-address-to-identity binding distributed by control plane 109. If traffic to the designated address is received from another node or from an unauthenticated source, proxy node 106 may drop the traffic and may revoke or reissue the designated address to prevent misuse while preserving reusability of the designated address for different nodes on a per-node basis.

For inbound packets received from external system 111 on the stitched connection, proxy node 106 relays the inbound traffic over the private network to node 105 using the designated address within internal domain 141. The relayed traffic may be encapsulated for transport security, tagged for policy auditing, and subject to the same identity validation and access controls as outbound traffic, ensuring that bidirectional communication remains mediated by proxy node 106.

Using proxy node 106 as a relay provides centralized mediation for communications between nodes in internal domain 141 and external system 111 in external domain 151. By returning a designated address drawn from a reserved address range and advertising routes for that range, proxy node 106 creates an indirection layer that allows traffic to be transparently intercepted and controlled without requiring changes to applications executing at node 105 or to external system 111. To external system 111, communications appear to originate from a single network entity—proxy node 106—enabling external system 111 to provide a service, session, or connection to what appears to be one node, while proxy node 106 distributes access to that service among multiple nodes in internal domain 141. This relay architecture enables proxy node 106 to enforce security policies, apply protocol-specific handling, translate network addresses, and multiplex or demultiplex traffic for different internal nodes while preserving a communication model that appears direct from the perspective of node 105.

The relay role of proxy node 106 also enables identity-aware authorization using identity information distributed within the private network by control plane 109. Control plane 109 may disseminate identity records, cryptographic credentials, or verification material such that proxy node 106 can determine an identity associated with traffic received from node 105, for example by validating secure tunnel metadata, client certificates, signed tokens, or other authenticated signals bound to the source address or connection. Proxy node 106 may evaluate this identity in combination with policy rules, device posture, and configuration to determine whether traffic from node 105 is permitted to reach external system 111, and may continuously re-evaluate authorization during the lifetime of the stitched connection. If authorization fails, if policy changes, or if inactivity is detected, proxy node 106 may terminate the relayed communication and release the designated address back to the reserved address range, ensuring both security and efficient reuse of proxy resources while maintaining a centralized and controllable interface between internal domain 141 and external domain 151.

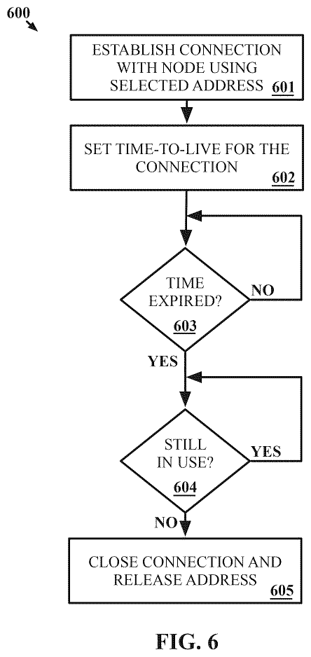

FIG. 6 illustrates operation 600 to enable controlled communication between nodes in a private network and resources. Operation 600 is an example of how proxy node 106 may implement a time-to-live mechanism for connections established through proxy node 106 in order to manage limited address resources and connection state. In this example, node 105 establishes a connection with proxy node 106 by directing traffic to a reserved address selected by proxy node 106 (step 601). The reserved address may have been previously returned to node 105 in response to a name-resolution request for an identifier associated with external system 111, and routing advertisements within internal domain 141 ensure that traffic for the reserved address is delivered to proxy node 106.

Proxy node 106 sets a time-to-live for the connection (step 602). The time-to-live may be set when the address is selected such that the address can be reassigned if traffic is not received from node 105 before the timer expires. The time-to-live may represent a soft lease on the reserved address and may be selected based on expected connection behavior, protocol type, administrative policy, or observed network conditions. In some implementations, different time-to-live values may be applied to different classes of traffic, different identifiers, or different nodes, allowing proxy node 106 to balance responsiveness with efficient reuse of the reserved address range.

Proxy node 106 allows the connection to remain open with node 105 using the selected address at least until the time-to-live expires (step 603). During this period, proxy node 106 maintains state associating the reserved address with node 105 and with external system 111 so that traffic can be correctly stitched and relayed. The time-to-live may function independently of application-level session management, allowing proxy node 106 to reclaim unused addresses even if higher-level protocols do not explicitly signal session termination.

Since the time-to-live may be relatively short (e.g., 5 seconds), there is a chance the connection may still be in active use. Rather than interrupting an active connection, proxy node 106 allows the connection to remain open while still in use (step 604). Proxy node 106 may determine that the connection is still in use by monitoring traffic activity, observing acknowledgment patterns, tracking protocol-specific keep-alive messages, or maintaining counters or timestamps associated with recent packet exchange. In some examples, proxy node 106 may reset or extend the time-to-live while traffic continues to flow, effectively transitioning from a fixed lease to a sliding expiration model that favors active sessions without permanently reserving addresses. In some examples, proxy node 106 maintains, for each designated address, a record of a last-used time indicating when traffic was most recently observed for that address. When allocating a designated address from the reserved address range, the proxy node may preferentially select an address with a last-used time indicating that it has been idle beyond a configurable expiration interval (e.g., threshold amount of time). By expiring address reservations based on observed inactivity rather than solely on fixed lifetimes, proxy node 106 can reclaim and reuse addresses while reducing the likelihood of premature release of addresses still associated with active communication.

When proxy node 106 determines the connection is no longer in use, proxy node 106 closes the connection and releases the address to be used for other connections (step 605). Proxy node 106 may close both an internal component of the connection with node 105 and an external component of the connection with external system 111. The determination that a connection is no longer in use may be based on inactivity thresholds, explicit session termination signals, policy updates received from control plane 109, or revocation of identity credentials associated with node 105. Releasing the reserved address allows proxy node 106 to make the address available for subsequent name-resolution requests and connections from node 105 or from other nodes operating in internal domain 141. Should node 105 need to contact external system 111 again, node 105 will need to contact proxy node 106 again, such as by issuing another name-resolution request, to obtain a newly allocated reserved address. This approach ensures efficient utilization of the reserved address range while maintaining controlled, stateful mediation of access to resources in external domain 151.

In addition to inactivity or time-to-live expiry, proxy node 106 may remove the association between the designated address and the identifier in response to satisfaction of a policy, such as completion of a transaction limit, expiration of a time-window grant, attainment of a data-transfer quota, or receipt of an administrative revocation from control plane 109. Upon such satisfaction, proxy node 106 may terminate the stitched connection, release the designated address to the reserved address range, and record the policy event for audit.

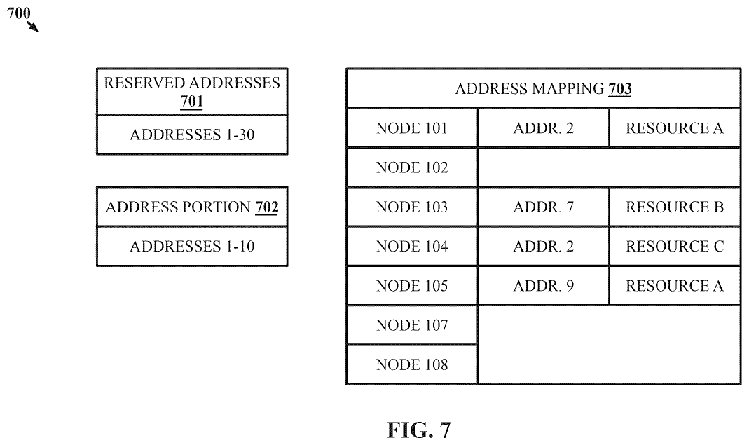

FIG. 7 illustrates address resources 700 for enabling controlled communication between nodes in a private network and resources. Address resources 700 include reserved addresses 701, address portion 702, and address mapping 703. Reserved addresses 701 include a range of 30 addresses, referred to as addresses 1-30, that control plane 109 reserves in this example for use by proxy nodes in internal domain 141. The reserved addresses 701 form a dedicated address space that is distinct from addresses assigned directly to nodes in internal domain 141, allowing traffic directed to those addresses to be recognized and routed as proxy-mediated traffic. In other examples, reserved addresses 701 may include fewer or more addresses, may be non-contiguous, or may include a mix of IPv4 and IPv6 addresses depending on the addressing scheme used within internal domain 141.

Address portion 702 represents a portion of reserved addresses 701 that is allocated to proxy node 106. Since addresses 1-10 of addresses 1-30 are allocated to proxy node 106, addresses 11-30 may be divided amongst proxy node 107 and proxy node 108. The size of address portion 702 may be determined by control plane 109 based on expected traffic volume, historical usage, or hardware capabilities of proxy node 106. In some implementations, address portion 702 may be resized dynamically, for example by transferring addresses from proxy node 107 or proxy node 108 to proxy node 106 during periods of increased demand. Address portion 702 may also be reassigned during failover events so that proxy node 106 temporarily services addresses previously allocated to another proxy node.

Address mapping 703 is an example mapping that proxy node 106 may use to track which addresses are in use for which nodes. According to address mapping 703 at the point in time represented, node 101 is using address 2 to access resource A, node 102 is using address 7 to access resource B, node 104 is using address 2 to access resource C, and node 105 is using address 9 to access resource A. This example demonstrates that the same reserved address may be reused for different nodes by proxy node 106, even when those nodes are accessing different resources, while proxy node 106 distinguishes the traffic based on node identity, connection context, or tunnel state. Address mapping 703 enables proxy node 106 to multiplex multiple internal connections onto addresses from address portion 702 while maintaining isolation between sessions.

In other examples, address mapping 703 may store additional information relevant to proxy node 106's operation as a proxy node, such as identifiers associated with external systems, connection state, time-to-live values, last-activity timestamps, policy decisions, or identity information associated with the requesting nodes. Address mapping 703 may also associate multiple identifiers with a single node, allowing node 105, for example, to access multiple resources through different designated addresses concurrently or sequentially. While there are entries for other nodes shown for illustrative purposes, address mapping 703 does not currently show an address associated with every node in internal domain 141, reflecting that not all nodes are actively communicating with external resources at the same time. Other examples may instead omit entries entirely for nodes without active associations, or may include placeholder entries indicating eligibility or pre-allocation status. Address mapping 703 may be maintained in volatile memory for fast access, persisted to storage for recovery, or replicated to other proxy nodes or control plane 109 to support failover, auditing, or coordinated resource management.

In other examples, address mapping 703 may maintain multiple entries for the same node to represent concurrent access to a plurality of identifiers, each entry associating a respective designated address selected from address portion 702 with a different identifier. For example, node 105 may simultaneously use address 5 for resource A, address 6 for resource B, and address 8 for resource C, with each association governed by its own time-to-live and policy grants.

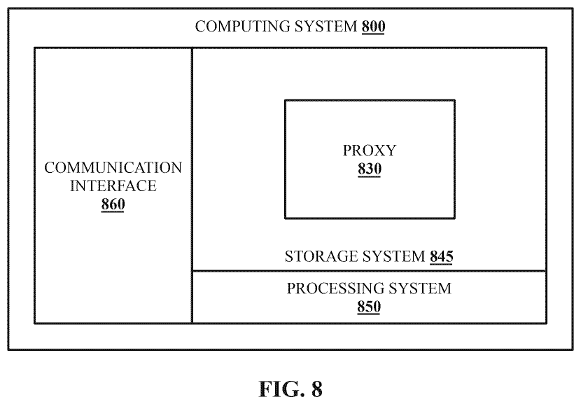

FIG. 8 illustrates computing system 800 for a computing system for enabling controlled communication between nodes in a private network and resources. Computing system 800 is representative of any computing system or systems with which the various operational architectures, processes, scenarios, and sequences disclosed herein can be implemented. Computing system 800 is an example architecture for nodes 101-108, control plane 109, and external system 111, although other examples may exist. Computing system 800 includes storage system 845, processing system 850, and communication interface 860. Processing system 850 is operatively linked to communication interface 860 and storage system 845. Communication interface 860 may be communicatively linked to storage system 845 in some implementations. Computing system 800 may further include other components such as a battery and enclosure that are not shown for clarity.

Communication interface 860 comprises components that communicate over communication links, such as network cards, ports, radio frequency (RF), processing circuitry and software, or some other communication devices. Communication interface 860 may be configured to communicate over metallic, wireless, or optical links. Communication interface 860 may be configured to use Time Division Multiplex (TDM), Internet Protocol (IP), Ethernet, optical networking, wireless protocols, communication signaling, or some other communication format—including combinations thereof. Communication interface 860 may be configured to communicate with one or more web servers and other computing systems via one or more networks.

Processing system 850 comprises microprocessor and other circuitry that retrieves and executes operating software from storage system 845. Storage system 845 may include volatile and nonvolatile, removable, and non-removable media implemented in any method or technology for storage of information, such as computer readable instructions, data structures, program modules, or other data. Storage system 845 may be implemented as a single storage device but may also be implemented across multiple storage devices or sub-systems. Storage system 845 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no interpretations would storage media of storage system 845, or any other computer-readable storage medium herein, be considered a transitory form of signal transmission (often referred to as “signals per se”), such as a propagating electrical or electromagnetic signal or carrier wave.

Processing system 850 is typically mounted on a circuit board that may also hold the storage system. The operating software of storage system 845 comprises computer programs, firmware, or some other form of machine-readable program instructions. The operating software of storage system 845 comprises proxy module 830. The operating software on storage system 845 may further include an operating system, utilities, drivers, network interfaces, applications, or some other type of software. When read and executed by processing system 850, the operating software on storage system 845 directs computing system 800 to control access of nodes in a private network domain to an external domain.

In at least one example, proxy module 830 directs processing system 850 to receive a reserved address range in an internal domain of the private network. Proxy module 830 further directs processing system 850 to receive a Domain Name System (DNS) request from a requesting node in the internal domain that indicates a domain name corresponding to an external domain and allocate a designated address from the reserved address range to communications associated with the DNS request. Proxy module 830 also directs processing system 850 to transmit, to the requesting node, a name-resolution response that includes the designated address, receive traffic directed to the designated address over the private network, and relay the traffic to a resource in the external domain.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for enabling access to external systems from within a private network, the method comprising:
allocating, for a proxy node within an internal domain of the private network, a reserved address range in the internal domain;
receiving, at the proxy node, a name-resolution request from a requesting node in the internal domain indicating an identifier corresponding to an external system in an external domain;
in response to the name-resolution request, selecting a designated address from the reserved address range and associating the designated address with the identifier and the requesting node in a mapping maintained by the proxy node;
transmitting, to the requesting node, a name-resolution response including the designated address; and
relaying traffic exchanged between the requesting node and the external system via the proxy node by translating traffic addressed to the designated address into traffic addressed to the external system.

2. The method of claim 1, wherein selecting the designated address comprises:
selecting the designated address from addresses in the reserved address range that are not already mapped for the requesting node.

3. The method of claim 1, comprising:
advertising, from the proxy node to nodes in the internal domain, one or more subnet routes that encompass the reserved address range.

4. The method of claim 1, comprising:
enforcing, at the proxy node and prior to relaying the traffic, one or more access policies based on user identity information associated with the requesting node.

5. The method of claim 1, comprising:
removing the association between the designated address and the identifier from the mapping in response to occurrence of at least one of:
a lapse of a time-to-live associated with the association,
inactivity of a connection using the designated address, and
a satisfaction of a policy.

6. The method of claim 1, wherein:
the name-resolution request is a Domain Name System (DNS) request; and
transmitting the name-resolution response comprises returning the designated address as a response to the DNS request from a DNS service for the private network.

7. The method of claim 6, comprising:
instructing one or more nodes in the internal domain to direct DNS requests for a set of identifiers, including the identifier, to the DNS service.

8. The method of claim 1, wherein relaying the traffic comprises:
establishing, by the proxy node, an outbound connection to the external system; and
stitching the outbound connection with an inbound connection to the designated address from the requesting node.

9. The method of claim 1, wherein:
the mapping maintained by the proxy node associates a plurality of identifiers with respective designated addresses selected from the reserved address range for the requesting node.

10. The method of claim 1, comprising:
deploying a plurality of proxy nodes;
allocating different portions of the reserved address range among the plurality of proxy nodes; and
in response to a failover event at a failed node of the plurality of proxy nodes, transferring a portion of the different portions allocated to the failed node to a different proxy node of the plurality of proxy nodes.

11. An apparatus implementing a node of a private network to enable access to external systems by nodes in the private network, the apparatus comprising:
one or more computer-readable storage media;
one or more processing systems operatively coupled with the one or more computer-readable storage media; and
program instructions stored on the one or more computer-readable storage media that, when read and executed by the one or more processing systems, direct the apparatus to:
receive a reserved address range in an internal domain of the private network;
receive a Domain Name System (DNS) request from a requesting node in the internal domain that indicates a domain name corresponding to an external domain;
allocate a designated address from the reserved address range to communications associated with the DNS request;
transmit, to the requesting node, a name-resolution response that includes the designated address;
receive traffic directed to the designated address over the private network; and
relay the traffic to a resource in the external domain.

12. The apparatus of claim 11, wherein the requesting node is directed by a control plane of the private network to direct DNS requests with the domain name to a private network address of the apparatus.

13. The apparatus of claim 11, wherein the program instructions further direct the apparatus to:
advertise, within the internal domain, one or more subnet routes that include the reserved address range.

14. The apparatus of claim 11, wherein the program instructions further direct the apparatus to:
receive policy grants indicating allowed traffic based on at least one of: user identity, device identity, group membership, device posture, and administrative configuration; and
relay the traffic in response to determining at least one of the policy grants allows the traffic.

15. The apparatus of claim 11, wherein the program instructions further direct the apparatus to:
assign a time-to-live to the designated address in association with the DNS request; and
in response to the time-to-live expiring and inactivity of the traffic, release the designated address to the reserved address range.

16. The apparatus of claim 11, wherein the designated address is assigned on a per-node basis such that the designated address is reusable for different nodes, and wherein the program instructions direct the apparatus to:
before relaying the traffic determining the traffic is received from the requesting node rather than another node on the private network.

17. The apparatus of claim 11, wherein the traffic is received over an internal connection in the internal domain, and wherein the program instructions further direct the apparatus to:
establish an outbound connection to the resource; and
stich the internal connection and the outbound connection together.

18. The apparatus of claim 11, wherein the program instructions direct the apparatus to:
receive inbound traffic from the resource; and
relaying the inbound traffic over the private network to the requesting node.

19. A system forming a private network to enable access to external systems by nodes in the private network, the system comprising:
a control plane configured to:
identify a set of domain names to be mediated by a proxy node operating in an internal domain of the private network;
configure the proxy node with a reserved address range and with instructions to respond to name-resolution requests for the set of domain names with designated addresses drawn from the reserved address range; and
direct nodes in the internal domain to send the name-resolution requests for the set of domain names to the proxy node; and
the proxy node configured to:
maintain mappings between designated addresses in the reserved address range, the nodes, and the set of domain names;
provide name-resolution responses to the nodes in the internal domain that include the designated addresses;
advertise one or more subnet routes to the reserved address range within the internal domain; and
relay traffic between the nodes in the internal domain and external systems indicated by the domain names using network address translation based on the mappings.

20. The system of claim 19, comprising:
the nodes configured to:
receive the name-resolution responses from the proxy node; and
direct traffic to the designated addresses included in the name-resolution responses.
